(19) United States
(12) Patent Application Publication
(10) Pub. No.: US 2005/0180895 A1
(43) Pub. Date: Aug. 18, 2005

(54) Test tube rack

(75) Inventor: Teruaki Itoh, Kumamoto-shi (JP)

Correspondence Address: NIXON & VANDERHYE, PC, 901 NORTH GLEBE ROAD, 11TH FLOOR, ARLINGTON, VA, 22203, US

(73) Assignee: IDS COMPANY, LTD, Kumamoto-shi (JP)

(21) Appl. No.: 11/057,156

(22) Filed: Feb. 15, 2005

(30) Foreign Application Priority Data
Feb. 17, 2004 (JP) 2004-040023

(51) Int. Cl. B01L 9/00

(52) U.S. Cl. 422/104

(57) ABSTRACT

A test tube rack has a rack main body, a test tube insertion hole, a test tube bottom receiving part, and a test tube fitting adapter. The rack main body is constructed in at least three stages in which an upper plate, a middle plate and a lower plate are arranged parallel with an interval. The test tube insertion hole is provided on the upper plate and middle plate. The test tube bottom receiving part is provided in the lower plate. The test tube fitting adapter is provided in the test tube insertion hole, and supports a test tube with a different outside diameter. The test tube is supported at three positions such as the upper plate,the middle plate, and the lower plate, and held in the vertically stood state.

### CROSS-REFERENCE TO RELATED APPLICATIONS

This application is based upon and claims the benefit of priority from prior Japanese Patent. Application No. 2004-040023, filed Feb. 17, 2004, the entire contents of which are incorporated herein by reference.

### BACKGROUND OF THE INVENTION

1. Field of the Invention

The present invention relates to a test tube rack which is used to store a test tube containing a sample such as blood, and to carry the test tube for serving or pouring the sample to a test tube.

2. Description of the Related Art

A test tube containing a sample such as blood is made of transparent glass, and the upper end opening is stopped by a cap made of rubber or synthetic resin. A test tube is stored and carried along a carrying path in the state held vertically in a test tube rack, in order to store the test tube with the sample contained or to carry the test tube to respective processing sections to serve or pour the sample to a test tube.

A test tube rack has a plurality of test tube fitting adapters to hold a test tube vertically and stably. Each test tube fitting adapter of the test tube rack is constructed to hold the middle part of a test tube to keep the test tube vertical even if a test tube with a different outside diameter is selectively inserted.

A test tube fitting adapter to hold a test tube one by one has a base part constituting the main body of the adapter. The base part has a projection which is fit in a guide rail of a carrying system, in the outer circumference of the proximal end. In the center of the base part, a cylindrical hollow portion to house a test tube is formed in a given depth from the top end toward the bottom end of base part. A test tube adapter which has a test tube holding piece to hold selectively a test tube with a different outside diameter is disclosed in Jpn. Pat. Appln. KOKAI Publication No. 2003-211006.

However, the test tube adapter disclosed in Jpn. Pat. Appln. KOKAI Publication No. 2003-211006 has a plurality of leaf springs in the cylindrical hollow portion of the adapter main body. The leaf spring has a contact part to contact the outer circumference of a test tube to hold. The adapter also has one O-ring which surrounds and bundles the outside of the leaf springs to press the contact part of the leaf spring to the outer circumference of a test tube by a certain force.

As above described, a test tube adapter has a leaf spring with a complicated structure, and the elastic force of a leaf spring is supported by one O-ring. Thus, if more than one test tube adapter is arranged in the main body of the rack, the assembling workability is bad causing an increase in the cost. Moreover, maintenance is troublesome if the O-ring is damaged.

### BRIEF SUMMARY OF THE INVENTION

It is an object of the present invention to provide a test tube rack which prevents deformation of a test tube holding piece even if it is repeatedly used, and improves the durability.

A test tube rack according to the present invention has a rack main body, a test tube insertion hole, a test tube bottom receiving part, and a test tube fitting adapter. The rack main body is constructed in at least three stages in which an upper plate, a middle plate and a lower plate are arranged parallel with an interval. The test tube insertion hole is provided on the upper plate and middle plate with overlapping arrangement. The test tube bottom receiving part is provided in the lower plate at a position where overlaps with the test tube insertion hole. The test tube fitting adapter is provided in each test tube insertion hole of the upper plate and middle plate. The test tube fitting adapter consists of a test tube holding piece and a coil spring. The test tube holding piece is provided in more than one piece with an interval in the circumferential direction of the test tube insertion hole, and elastically deformed along the radial direction of the test tube insertion hole to meet a test tube with a different outside diameter. The coil spring is annular and fit by surrounding these test tube holding pieces, just like bundling them.

In the preferable form of the test tube rack, the upper and middle plates are made of synthetic resin and molded in one body with the test tube fitting adapter. Otherwise, the test tube fitting adapter is made of synthetic resin and molded separately from the upper and middle plates, and fit in each test tube insertion hole.

According to this test tube rack, deformation of the test tube holding piece is prevented even if it is repeatedly used, and excellent durability is obtained.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view of a test tube rack according to a first embodiment of the present invention;

FIG. 2 is a sectional view of the test tube rack taken along lines F2-F2 of FIG. 1;

FIG. 3 is an enlarged longitudinal sectional view showing a part of the test tube rack holding a test tube; and

FIG. 4 is an exploded perspective view of a test tube rack according to a second embodiment of the invention.

### DETAILED DESCRIPTION OF THE INVENTION

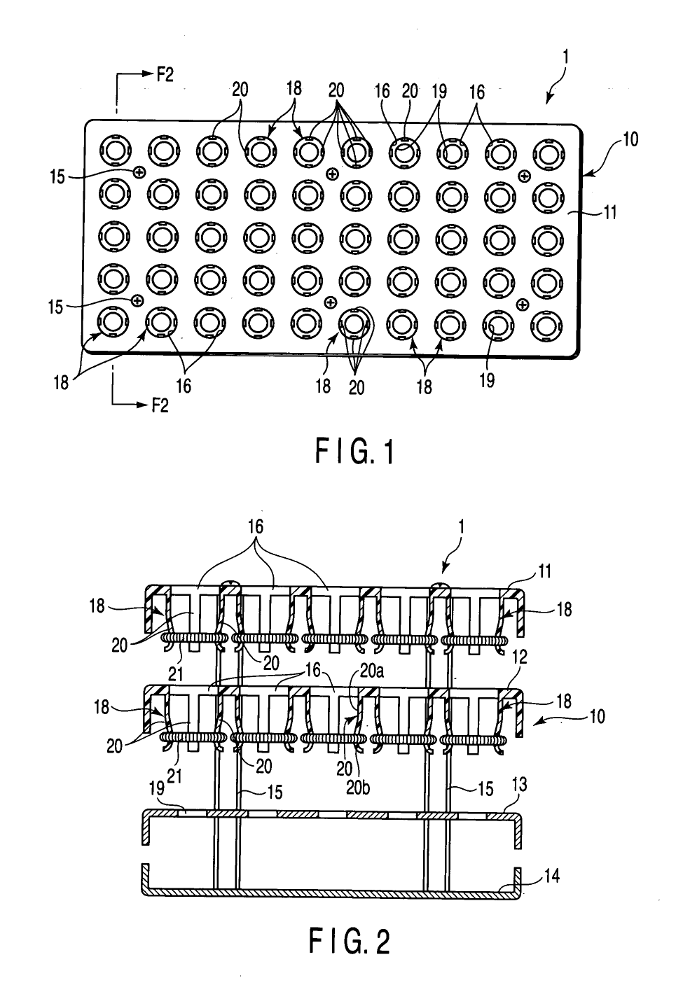

A first embodiment according to the present invention will be explained with reference to FIGS. 1 to 3. A test tube rack 1 shown in FIG. 1 has a rack main body 10, a test tube insertion hole 16, a test tube bottom receiving portion 19, and a test tube fitting adapter 18. The rack main body 10 is constructed in four stages in which an upper plate 11, a middle plate 12, a lower plate 13 and a base plate 14 are arranged parallel with an interval. The upper plate 11, middle plate 12, lower plate 13 and base plate 14 are connected and held parallel by a plurality of spacer bolts 15.

The upper plate 11 and middle plate 12 are made of synthetic resin and molded as one rectangular body. The lower plate 13 and base plate 14 are made of metal plate, for example, stainless steel, and formed rectangular with the same outside dimensions as those of the upper plate 11 and middle plate 12.

The upper plate 11 and middle plate 12 are formed with the same shape and dimensions. Therefore, explanation will be given only on the upper plate 11. Explanation on the middle plate 12 will be omitted. The upper plate 11 has a plurality of test tube insertion holes 16 arranged in the lengthwise and crosswise of a square array. The inside diameter of the test tube insertion hole 16 is large enough to permit insertion of several sorts of test tube 17 with different outside diameters. The test tube fitting adapter 18 is made of synthetic resin and formed as one body with the upper plate 11 in the test tube insertion hole 16.

The lower plate 13 has the test tube bottom receiving portion 19 at a position lying on the test tube insertion hole 16 when viewed from the upper side. The test tube bottom receiving portion 19 is formed as a circular hole with the diameter a little smaller than the outside diameter of the test tube 17, in order to receive a hemispherical bottom 17a of the test tube 17.

The test tube fitting adapter 18 consists of a plurality of test tube holding pieces 20, four in this embodiment, and a coil spring 21. The test tube holding pieces 20 are arranged with equal interval in the circumferential direction of the test tube insertion hole 16, and extended downward from the test tube insertion hole 16 of the upper plate 11. Each test tube holding piece 20 is formed straight in the upper half 20a from the base in the upper plate 11, and bent outward like an arc in the lower half 20b.

The coil spring 21 is made of a steel wire coil curved annularly, and fit in the periphery of the test tube holding pieces 20 of one test tube fitting adapter 18, just like binding the test tube holding pieces 20. The coil spring 21 prevents the test tube holding piece 20 from being forcibly deformed outside and plastically deformed. The lower half 20b of the test tube holding piece 20 is bent outside serving as a stopper, and the coil spring 21 will not come off from the lower half 20b of the test tube holding piece 20 even if a fixing means is not provided.

The coil spring 21 is not used to gather elastically the test tube holding pieces 20 inside, but to lighten the fatigue caused by the repetitive insertion of the test tube 17 into the test tube fitting adapter 18. Therefore, the coil spring 21 has the elastic force sufficient to extend the inserted test tube 17, and protects the test tube holding piece 20 that repeats elastic deformation.

When the test tube 17 is inserted into the test tube insertion hole 16, the test tube holding piece 20 is spread corresponding to the outside form of the test tube 17, and elastically deformed in the radial direction, holding the body of the test tube 17. The test tube fitting adapter 18 can fit and hold a plurality of test tubes with different outside diameters without rattling.

The test tube rack 1 has the test tube fitting adapter 18 in the upper plate 11 and middle plate 12, and has the test tube bottom receiving portion 19 in the lower plate 13. Therefore, when the test tube 17 is inserted from the upper side of the upper plate 11 into the test tube insertion hole 16, the body of the test tube is held by the test tube fitting adapter 18 provided in the upper plate 11 and middle plate 12, and the bottom 17a is supported by the test tube bottom receiving portion 19. Namely, the test tube 17 is supported at three positions and held in the vertically stood state.

Even if the test tube 17 inserted into the test tube fitting adapter 18 receives an external force to turn down the test tube 17, the test tube rack 1 can protect the test tube fitting adapter 18 and improve the durability of the test tube fitting adapter 18.

In this embodiment, the test tube rack 1 has four test tube holding pieces 20 in the test tube fitting adapter 18, but the number of the test tube holding pieces 20 is not limited to this. The rack main body 10 has the three-stage structure consisting of the upper plate 11, middle plate 12 and lower plate 13, but it is permitted to add a plate.

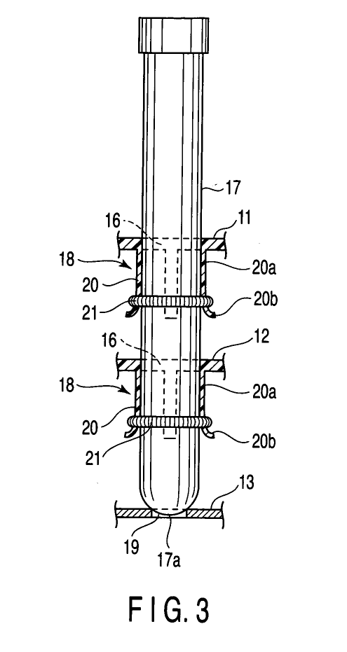

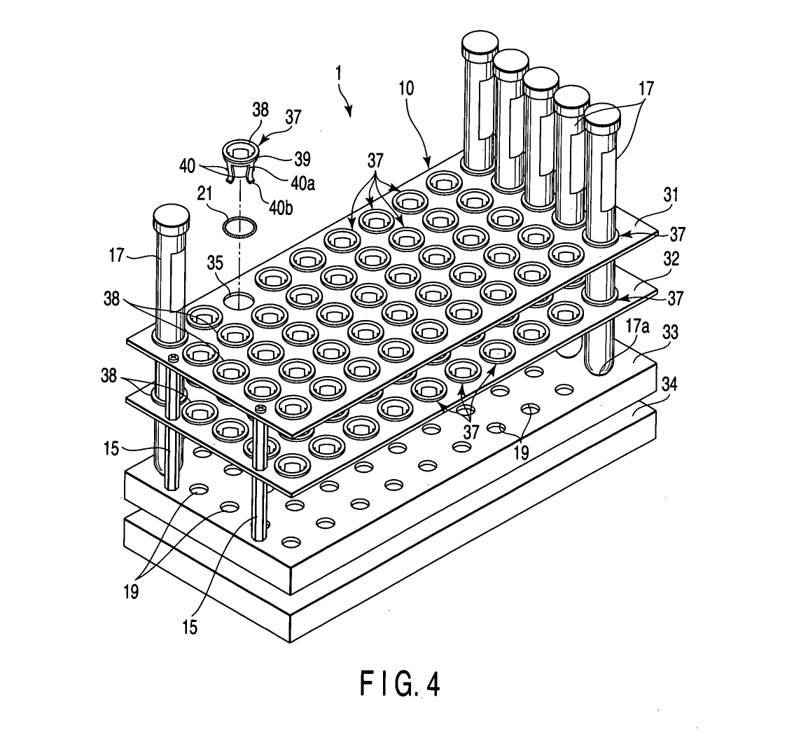

Explanation will now be given on a second embodiment of the invention with reference to the test tube rack 2 shown in FIG. 3. The same reference numerals are given to the same components as the test tube rack 1 shown in the first embodiment, and explanation will be omitted. In the test tube rack 2 shown in FIG. 4, the upper plate 31, middle plate 32, lower plate 33 and base plate 34 are made of metal plate, for example, stainless steel. The upper plate 31 and middle plate 32 are formed with the same shape and dimensions. Therefore, explanation will be given only on the upper plate 31. Explanation on the middle plate 32 will be omitted.

The upper plate 31 has a plurality of test tube insertion holes 35 arranged in the lengthwise and crosswise of a square array. The inside diameter of the test tube insertion hole 35 is sufficient to fit a test tube fitting adapter 37. The test tube fitting adapter 37 is large enough to permit insertion of several kinds of test tube 17 with different outside diameters. The test tube fitting adapter 37 consists of an annular part 38, a test tube holding piece 40, and a coil spring 21. The annular part 38 is removably inserted into the test tube insertion hole 35. The annular part 38 has a flange 39 which contacts the opening edge of the test tube insertion hole 35. The test tube holding pierce 40 is provided in plural number, four in this embodiment, with equal interval along the circumferential direction of the annular part 38. The test tube holding piece 40 is made of synthetic resin and formed as one body with the annular part 38, just like extending downward from the annular part 38. The test tube holding pierce 40 is formed straight in the upper half 40a from the base in the annular part 38, and bent outward like an arc in the lower half 40b.

The coil spring 21 is made of a steel wire coil curved annularly, and fit in the periphery of the test tube holding piece 40 of one test tube fitting adapter 37, just like binding the test tube holding piece 40. The coil spring 21 prevents the test tube holding piece 40 from being forcibly deformed outside and plastically deformed. The lower half 40b of the test tube holding piece 40 is bent outside serving as a stopper, and the coil spring 21 will not come off from the lower half 40b of the test tube holding piece 40 even if a fixing means is not provided.

When the test tube 17 is inserted into the test tube fitting adapter 37, the test tube holding piece 40 is spread corresponding to the outside form of the test tube 17, and elastically deformed in the radial direction, holding the body of the test tube 17. The test tube fitting adapter 37 can fit and hold a plurality of test tubes with different outside diameters without rattling.

In the test tube rack 2 of this embodiment, the test tube fitting adapter 37 is fit in the test tube insertion hole 35 provided at a position where the hole 35 of the upper plate 31 overlaps with the hole 35 of the middle plate 32, and the test tube bottom receiving portion 19 is provided in the lower plate 33. Therefore, when the test tube 17 is inserted from the upper side of the upper plate 31 into the test tube fitting adapter 37, the body of the test tube 17 is held by the test tube holding piece 40 of the test tube fitting adapter 37 provided in the upper plate 31 and middle plate 32, and the bottom 17a is supported by the test tube bottom receiving portion 19. Namely, the test tube 17 is supported at three positions and held in the vertically stood state.

In the test tube rack 2 of the second embodiment, the test tube fitting adapter 37 can be removed. Therefore, in addition to the same effect as the test tube rack 1 of the first embodiment, the using period of the test tube rack 2 can be extended by replacing the test tube fitting adapter 37, and the test tube rack 2 is applicable to many kinds of test tubes with different outside diameters when the test tube fitting adapter 37 is changed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A test tube rack comprising:
a rack main body which is constructed in at least three stages in which an upper plate, a middle plate and a lower plate are arranged parallel with an interval;
a test tube insertion hole which is provided on the upper plate and middle plate with overlapping arrangement;
a test tube bottom receiving part which is provided in the lower plate at a position where overlaps with the test tube insertion hole; and
a test tube fitting adapter which is provided in the test tube insertion hole of the upper plate and middle plate;
wherein the test tube fitting adapter has a test tube holding piece which is provided in more than one piece with an interval in the circumferential direction of the test tube insertion hole, and elastically deformed along the radial direction of the test tube insertion hole to meet a test tube with a different outside diameter; and
a coil spring formed annularly which is fit in the outer circumference of the test tube holding piece so as to bundle the test peace holding piece.

2. The test tube rack according to claim 1, wherein the upper plate and middle plate are made of synthetic resin and molded in one body with the test tube fitting adapter.

3. The test tube rack according to claim 1, wherein the test tube fitting adapter is made of synthetic resin, and fit in the test tube insertion hole provided in the upper plate and middle plate.
